(19) United States
(12) Patent Application Publication
(10) Pub. No.: US 2014/0274208 A1
(43) Pub. Date: Sep. 18, 2014

(54) Portable Three-in-One Mobile Phone Accessory

(71) Applicant: Robert Baschnagel, Long Island City, NY (US)

(72) Inventor: Robert Baschnagel, Long Island City, NY (US)

(21) Appl. No.: 13/845,596

(22) Filed: Mar. 18, 2013

(51) Int. Cl. H04M 1/725; H04M 1/02

(52) U.S. Cl. CPC H04M 1/72563; H04M 1/0254
USPC 455/557

(57) ABSTRACT

A portable three-in-one mobile phone accessory comprising a phone stand, a game control system and a docking station is disclosed. Said phone stand, game control system and docking station are built into one integrated device. Said accessory can be split into half so that a mobile phone can be held into said accessory vertically or horizontally. A user is able to charge a mobile phone and play games on the phone using the game control system in either an upright position or a horizontal position.

### CROSS-REFERENCE

This is a continuation-in-part application to the U.S. application Ser. No. 13/680,483, filed on Nov. 19, 2012, from which priority is claimed, and entirety of which is hereby incorporated by reference.

### BACKGROUND OF THE INVENTION

### Field of the Invention

The present invention relates to a mobile phone accessory, and more particularly, relates to portable three-in-one mobile phone accessory that has a phone stand, a game control system and a docking station that are integratedly built into one device.

Mobile phones now are commonly used by many consumers. Mobile phones now are not only a communication device, they are also widely used and entertainment device. Most of mobile phones have the functions of downloading and installing game software and many consumers play video games or other games on mobile phones. But playing games using the key pads of mobile phones is not as convenient as using game controllers that are easier to control and thus provide more excitements of gaming experiences.

Mobile phones are also used as iPod to play music, and most often users use earphones to play the sound of music. Sometimes it is desirable to be able to play the music in mobile phones with speakers.

Most of the time mobile phones are powered with rechargeable batteries and need to be charged often. The chargers provided by the mobile phone companies usually includes just a charger with a cord, which can provide no support to the mobile phones when sometimes it is more preferable to be able to hold mobile phones upright or horizontal.

Thus it is desirable to have a portable mobile phone accessory that can 1) charge mobile phones, 2) uphold mobile phones in the preferred positions, 3) dock mobile phones to play music via speakers, and 4) play games on mobile phones with game controllers.

Therefore, it is objective for present invention to produce a three-in-one mobile phone device that with a phone stand to hold mobile phones in desired positions, a docking station that can charge mobile phones and play music on mobile phones with speakers, and a game control system that can allow users of mobile phones to play games on the mobile phones with game controllers.

### SUMMARY OF THE INVENTION

In an exemplary embodiment of the present invention, there is disclosed a portable three-in-one mobile phone accessory, which comprises a phone stand, a game control system and a docking station. Said phone stand, game control system and docking station are built into one integrated device s that a user of the accessory of present invention can hold his/her mobile phone in either horizontal or vertical position as he/she prefers, charge the mobile phone, and at the same time, play games on the mobile phone with the built-in game control system. The game control system has at least on directional button, one game command button and a joystick built into the accessory. The game control system may connect to the mobile phone using Bluetooth technology. The accessory of present invention may also include an audio jack. When a mobile phone is docked to the accessory, the audio jack may go into the mobile phone so that the audio from the phone may be played via a speaker(s). The accessory of present invention can hold a mobile phone in a vertical position. The accessory of the present invention can be split in half, thus hold a mobile phone in a horizontal position. The phone stand has at lease two retractable legs, which are attached to the back member of the accessory. Said retractable legs can either locked to the back member, or release away from the back member.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1A is a prospective front view of one embodiment of the present invention.

FIG. 1B shows the device of FIG. 1A in a folded configuration.

FIG. 2A is a prospective back view of one embodiment of the present invention with arms in closed position.

FIG. 2B is a prospective back view of one embodiment of the present invention with the arms in an open position

FIG. 3 is an enlarged prospective front view of one embodiment of the present invention.

FIG. 4A is a top view of one embodiment of the present invention, whereas 4A showing the holes and cavity for receiving a charger cord and a charger head, respectively; and

FIG. 4B is a top view of one embodiment of the present invention, showing an iPhone™ charger head sitting in the cavity for receiving a charger head.

FIG. 5 is a prospective front view of one embodiment of present invention that the device can be split in half at the middle.

FIG. 6A is a prospective view of a mobile phone docked on one embodiment of the present invention, showing a mobile phone being held in an upright position in a non-split device.

FIG. 6B is a prospective view of a mobile phone docked on one embodiment of the present invention showing a mobile phone is held in horizontal position in a split device of present invention.

FIG. 7A is a prospective views of one embodiment of present invention with a audio jack, showing the audio jack is held upright on the bottom of the device.

FIG. 7B is the top view of 7A with an iPhone™ charger head sitting in the cavity for receiving a charger head.

FIG. 7C is a explosive view of a mobile phone connected to the phone charger and the audio jack.

FIG. 8A and FIG. 8B show the audio jack can be received into the device of the present invention horizontally.

FIG. 8C and FIG. 8D show the audio jack can be received into the device of the present invention vertically.

FIG. 9 showing a split device of present invention with an audio jack.

FIG. 10 showing a charger is securedly tied to the back of the device of present invention.

### DESCRIPTION OF THE PREFERRED EMBODIMENT

There is presently disclosed a portable three-in-one mobile phone accessory, comprising a phone stand, a game control system and a docking station, whereas the phone stand, game control system and docking station are built integratedly into one single device.

Referring to FIG. 1-6, the portable three-in-one mobile phone accessory 10 includes a front member 100, a back member 200, two side members 300, and a bottom member 400. The said front member 100, back member 200, two side member 300 and bottom member 400 together form an open cavity 500 for receiving a mobile phone 600 In one embodiment of the present invention, said accessory 10 also includes two retractable legs 700, which can be either locked into with the back member 200 or released away from the back member 200, as particularly show in FIGS. 2A and 2B. Said accessory also include a game control system 800 with at least one directional button 810, one game command button 820 and a joystick 830, that are built in the front member 100, as particularly shown in FIG. 1 and FIG. 3. Said game control system includes Bluetooth technology that allows a docked mobile phone 600 connect with the game control system so that a user may use the above referenced buttons to play and control a game in the mobile phone. One or more USB Bluetooth ports 840 may also be built into said accessory 10 for the purpose of connecting or charging using Bluetooth technology. As particularly shown in FIGS. 4A and 4B, the bottom member 400 may have a hole 410 to receiving a charger cord (not shown), and a molded cavity 420 for receiving a mobile phone charger head 920.

In one embodiment of the present invention, said accessory 10 can be split in half as shown in FIG. 5. The front member 100, back member 200 and bottom member 400 can be split at the middle into a left half piece (as 100A, 200A and 400A for front member, back member and bottom member) and a right half piece (as 100B, 200B, and 400B for front, back and bottom member). At the upper corner at split site of each half piece of front and back member, there is a quarter-circle curve-out, 110 for front member half pieces and 210 for back member half pieces. A disc 20 is connected to said quarter-circle curve-out 110 or 210. Each disc may either has a protrusion 22 or a groove 24 with it. For the two front half pieces, one has a disc with a protrusion 22 and one has a groove 24, and the same for the two back half pieces. The protrusion 22 and groove 24 can fit snugly with each other so that the snugly fitted protrusion and groove can fasten the two half pieces together to form a one piece of either front or back member.

As shown in FIG. 6, a mobile phone can be docked in the said accessory 10 either in a vertical upright position, or in a horizontal position when the accessory is split in half.

In another embodiment of the present invention, as shown in FIGS. 7 and 8, the accessory may also includes an audio jack 40. The audio jack may go into a mobile phone docked on the accessory 10 so that the audio may be played via speaker(s). The audio jack 40 may be received to the accessory 10 either in a horizontal position, or a vertical position, according to the preferred position that a mobile phone is placed into the accessory 10 by a user.

In another embodiment of the present invention, as shown in FIG. 9, the audio jack 40 can also be received by a split accessory either horizontally or vertically.

In another embodiment of the present invention, as shown in FIG. 10, the attractable legs may also further comprise a fasten mean 710, such as a hook (as shown in FIG. 10), or other structure, so that a charger cord 910 of a mobile phone charger 900 may be securedly tied to said fasten means, and/or to the disc 20 of the back member.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A portable three-in-one mobile phone accessory, comprising:
a. a docking station,
b. a game control system, and
c. a phone stand,
wherein said docking station, game control system and phone stand are built in one integrated device.

2. A portable three-in-one mobile phone accessory of claim 1, wherein said three-in-one accessory can be folded into a compact configuration.

3. A portable three-in-one mobile phone accessory of claim 2, further comprising a front member, a back member, two side members and a bottom member, and front, back, side, bottom members form a open cavity to hold a mobile phone; said front, back and bottom can be split at the middle into two pieces, a left half piece and a right half piece, so that said three-in-one accessory can be split in half, and when said three-in-one accessory is split in half, it holds a mobile phone horizontally, and when it is not split, it holds a mobile phone vertically.

4. A portable three-in-one mobile phone accessory of claim 3, wherein said game control system includes Bluetooth technology to connect said game control system with a docked mobile phone.

5. A portable three-in-one mobile phone accessory of claim 4, wherein said game control system further comprising at least one directional control button, at least one game command button and at least one joystick, built into said front member.

6. A portable three-in-one mobile phone accessory of claim 5, wherein there are at least one retractable leg attached to said back member.

7. A portable three-in-one mobile phone accessory of claim 6, wherein said front and back member each has a half-circle curve-out at the middle of its upper edge so that each left and right half piece of the front and back member has a quarter circle curve-out; each half piece of the front or back member has a disc built on said quarter circle curve-out, either with a protrusion or a groove, respectively, so that the protrusion can fit snugly into the groove to fasten the two half pieces together into one piece of front or back member.

8. A portable three-in-one mobile phone accessory of claim 7, wherein said buttons of game control system may be built on either left half piece, or right half piece of said front member, and said joystick is built on said disc on front member.

9. A portable three-in-one mobile phone accessory of claim 8, wherein the said bottom member further comprising a hole to receive a charger cord and a molded cavity for snugly fitting a mobile phone charger.

10. A portable three-in-one mobile phone accessory of claim 9, further comprising at least one USB Bluetooth charger port.

11. A portable three-in-one mobile phone accessory of claim 10, further comprising a removable audio jack that may go into a mobile phone when docked to the said portable three-in-one mobile phone accessory, said audio jack may either sits upwards vertically on either half pieces of the bottom member, or sits horizontally on each of the side member.

12. A portable three-in-one mobile phone accessory of claim 10, wherein each of said retractable legs connects to either the left half piece or the right half piece of the back member; said retractable leg further includes means of locking said retractable leg to the back member or releasing said retractable leg from the back member.

13. A portable three-in-one mobile phone accessory of claim 10, wherein each of the retractable leg further comprising a fasten means so that a charger cord can be securely tied to said portable three-in-one mobile phone accessory via said means.
